(19) United States
(12) Patent Application Publication
(10) Pub. No.: US 2024/0202494 A1
(43) Pub. Date: Jun. 20, 2024

(54) INTERMEDIATE MODULE NEURAL ARCHITECTURE SEARCH

(71) Applicant: Micron Technology, Inc., Boise, ID (US)

(72) Inventors: Andre Xian Ming Chang, Bellevue, WA (US); Abhishek Chaurasia, Redmond, WA (US)

(21) Appl. No.: 18/530,101

(22) Filed: Dec. 5, 2023

Related U.S. Application Data
(60) Provisional application No. 63/476,064, filed on Dec. 19, 2022.

(51) Int. Cl. G06N 3/04; G06F 16/2453

(52) U.S. Cl. CPC G06N 3/04; G06F 16/24549

(57) ABSTRACT

A system providing intermediate module neural architecture search is disclosed. The system searches a dynamic search space for candidate modules for a model of a neural network. The system analyzes an existing model and determines an insertion point at which the candidate modules may be inserted. A zero-shot metric is applied to the candidate modules to generate a ranking of candidate modules that may substitute an existing module at the insertion point. The system trains the candidate modules over a plurality of epochs on a distribution of data of a dataset. Based on the training, the system determines an accuracy rank for each of the candidate modules. The system executes candidate models including the candidate modules on a deep learning accelerator to determine a runtime execution rank for the candidate models. Based on the accuracy and runtime execution ranks, the system determines an optimal proposed model from the candidate models.

### RELATED APPLICATIONS

The present application claims priority to Prov. U.S. Pat. App. Ser. No. 63/476,064 filed Dec. 19, 2022, the entire disclosure of which application is hereby incorporated herein by reference.

### FIELD OF THE TECHNOLOGY

At least some embodiments disclosed herein relate to memory devices, neural networks, neural architecture search, and deep learning accelerators, and more particularly, but not limited to, a system for providing intermediate module neural architecture search.

### BACKGROUND

Currently, an increasing number of products and services rely on artificial intelligence to perform a variety of complex and tedious tasks and functions. As a result, the desire to innovate in the artificial intelligence realm to provide even further functionality and capabilities has increased substantially. Creating an artificial intelligence model is often a tedious and complex task, which involves significant amounts of brainstorming, development of artificial intelligence algorithms, software coding, and testing. An artificial intelligence model may include a plurality of layers to support the functionality that the artificial intelligence model is designed to perform. For example, the artificial intelligence model may include an input layer, an output layer, and any number of hidden layers in between the input layers and output layers. The input layer may accept input data and pass the input data to the rest of the neural network in which the artificial intelligence model resides. For example, the input layer may pass the input data to a hidden layer, which may then utilize artificial intelligence algorithms supporting the functionality of the hidden layer to transform the data, facilitate automatic feature creation, among other artificial intelligence functions. Once the data is processed by the hidden layer(s), the data may then be passed from the hidden layer(s) to the output layer, which may output the result of the processing.

Computer vision is just one example of a field of artificial intelligence that involves utilizing artificial intelligence models to derive meaningful information from various forms of media content, such as, but not limited to, digital images, videos, and/or other visual content. The content may be obtained from a variety of different devices and systems, such as cameras and monitoring systems. The information extracted from such content may be utilized by artificial intelligence models and systems to conduct actions, generate insight and recommendations, and train artificial intelligence models to enhance intelligence capabilities. Computer vision, for example, may incorporate the use of deep learning, vision transformers, and convolutional neural networks to facilitate object detection, image classification, object tracking, and content-based image retrieval.

As the complexity of datasets, the number of artificial intelligence use-case scenarios, and artificial intelligence accuracy requirements continues to increase over time, it is desirable to consistently be able to modify artificial intelligence models so that the models utilize fewer computer resources, while also being capable of generating higher accuracy results. The field of neural architecture search has the aim of discovering and identifying the optimal model for performing a particular task, however, modifying a model to achieve such goals often involves altering the entire model itself, including the model's layers, blocks, and modules supporting the overall functionality of the model. As a result, technologies and techniques for developing and enhancing artificial intelligence models may be enhanced to provide greater intelligence capabilities and accuracy, while simultaneously using fewer computer resources.

### BRIEF DESCRIPTION OF THE DRAWINGS

The embodiments are illustrated by way of example and not limitation in the figures of the accompanying drawings in which like references indicate similar elements.

FIG. 1 illustrates an exemplary system for providing intermediate module neural architecture search in accordance with embodiments of the present disclosure.

FIG. 2 illustrates an exemplary integrated circuit device including a deep learning accelerator and memory for use with the system of FIG. 1 according to embodiments of the present disclosure.

FIG. 3 illustrates an exemplary deep learning accelerator and memory configured to operate with an artificial neural network for use with the system of FIG. 1 according to embodiments of the present disclosure.

FIG. 4 illustrates an exemplary one-shot neural architecture according to embodiments.

FIG. 5 illustrates an exemplary zero-shot neural architecture according to embodiments.

FIG. 6 illustrates an exemplary use case for generating a proposed enhanced model utilizing intermediate neural architecture search according to embodiments of the present disclosure.

FIG. 7 illustrates an exemplary search space, an original user model for use with an artificial neural network, and selection of an insertion point for substituting an existing module according to embodiments of the present disclosure.

FIG. 8 illustrates application of a metric rank to candidate modules from a search space to facilitate generation of a ranking of candidate modules for substituting an existing module of a model according to embodiments of the present disclosure.

FIG. 9 illustrates utilizing intermediate module distillation applied to candidate modules of candidate models to determine accuracy ranks for each of the candidate modules according to embodiments of the present disclosure.

FIG. 10 illustrates executing candidate models including the candidate modules on a deep learning accelerator to determine runtime execution ranks for each of the candidate models according to embodiments of the present disclosure.

FIG. 11 shows an exemplary method for providing intermediate module neural architecture search in accordance with embodiments of the present disclosure.

FIG. 12 illustrates a schematic diagram of a machine in the form of a computer system within which a set of instructions, when executed, may cause the machine to facilitate intermediate module neural architecture search according to embodiments of the present disclosure.

### DETAILED DESCRIPTION

The following disclosure describes various embodiments for system 100 and accompanying methods for providing a framework for implementing intermediate module neural architecture search. In particular, embodiments disclosed herein provide the capability to optimize an existing artificial intelligence model in real-time by intelligently locating potential modules for inclusion into the existing artificial intelligence model and conducting testing on candidate modules to determine the optimal module(s) to replace or substitute existing modules within the existing artificial intelligence model to generate an optimized artificial intelligence model. For example, the system 100 and methods may include providing a framework that initially receives a user pre-trained model, and, using the functionality described herein, outputs an updated model with modifications to one or more layers, blocks, and modules to achieve similar or better accuracy, while also being able to have faster runtimes, such as on a deep learning accelerator. In certain embodiments, the system 100 and methods are able to generate the updated model without needing to provide the actual dataset for the particular task that the original existing artificial intelligence model was trained. For example, the system 100 and methods may be able to generate the updated model using a distribution of the data utilized for the particular task.

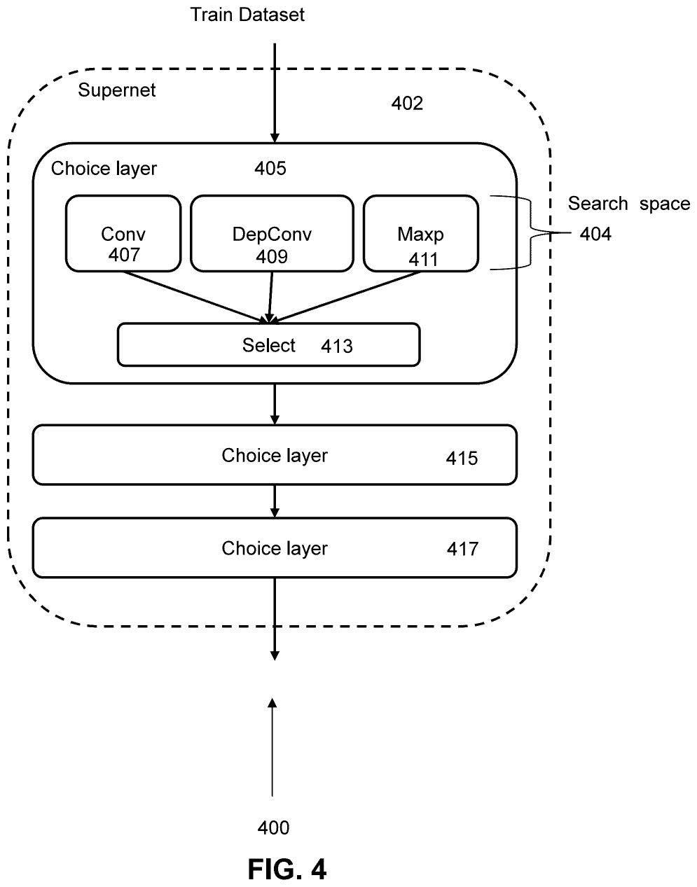

The system 100 and methods may employ the use of a novel form of neural architecture search, herein called intermediate neural architecture search or few-shot intermediate neural architecture search, to automate the process of discovery and optimization of neural network architectures. Generally, for neural architecture search, it is a challenge to train every possible neural network architectural design (e.g., model design) on different tasks because such training is prohibitively expensive. One exemplary approach, as shown in the architecture 400 of FIG. 4, employs the use of one-shot neural architecture search. In one-shot neural architecture search, a neural network model (i.e., artificial intelligence model) is made of a stack of layers (e.g., choice layers 405, 415, 417) that contains multiple modules of different types. In certain embodiments, this model with all module choices may be called a supernet 402 and it may be fully trained on a task dataset. After training the supernet, the modules of the model that are most relevant are chosen (e.g., at select step 413) and others are discarded. The foregoing process may be utilized to create the proposed neural network architecture model 400 that is optimized for accuracy and other metrics, such as hardware latency. In certain embodiments, the possible module choices may be referred to as a search space 404. In FIG. 4, non-limiting exemplary module choices may include a convolutional module 407 (“Conv”), a depthwise or depth separable convolutional module 409 (“DepConv”), a max pooling module (“MaxP”), any other module choices, or a combination thereof. In certain embodiments, the multiple layers may have many modules with shared parameters, which makes the supernet very large in terms of memory size. A drawback of one-shot neural architecture search is that one-shot neural architecture search still involves fully training the supernet, which consumes significant time and computer resources, especially for large search spaces. Furthermore, this also requires the task's data for training, which a user may refuse to share.

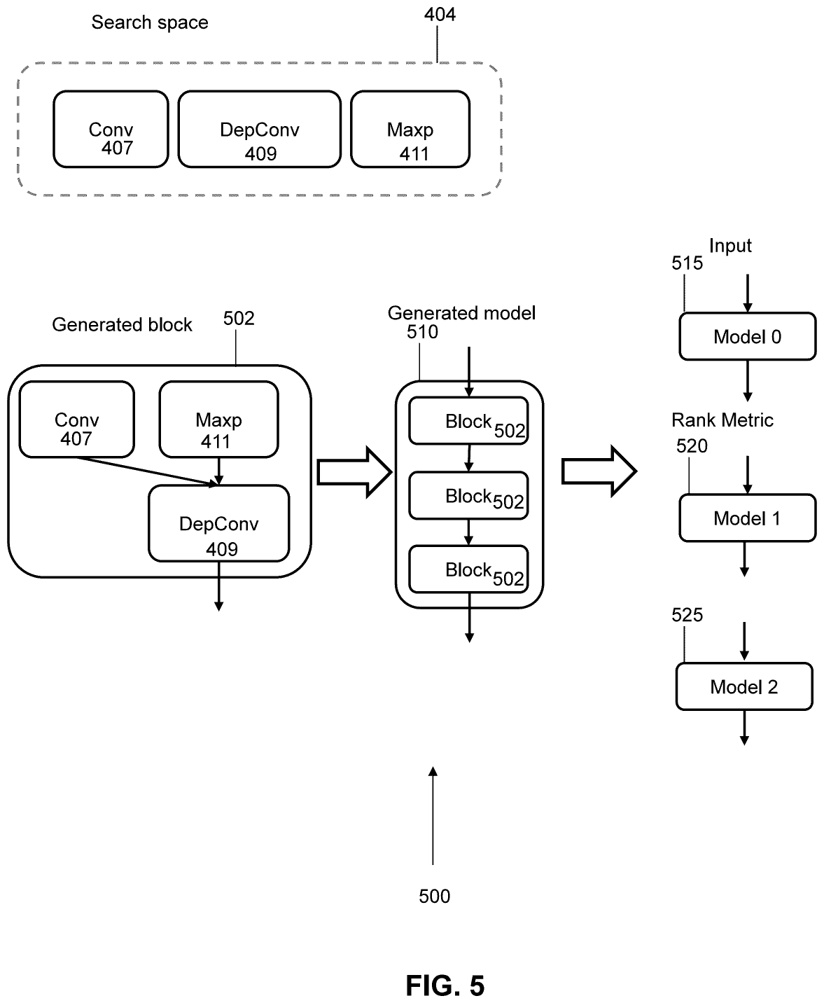

Another exemplary approach, as shown in the architecture 500 of FIG. 5, employs the use of zero-shot neural architecture search. In zero-shot neural architecture search, a neural network model may be generated by sampling the search space 404 and its properties are evaluated to predict whether the model is better than other candidates. One-shot neural architecture search may include generating blocks 502 of a model 510 that may include any number of modules that may be in a specific configuration (e.g., the convolutional module 407 and the max pooling module 411 outputs may serve as inputs to the depth separable module 409. In certain embodiments, the evaluation conducted during zero-shot neural architecture search may not require fully training the neural network model. For example, one backpropagation on random inputs may be utilized to obtain gradients. Some zero-shot neural architecture search implementations may not require task data to rank models, such as Model 0 515, Model 1 520, and Model 2 525, as shown in FIG. 5. The foregoing sampled models, for example, may be evaluated using a metric that attempts to predict final model accuracy. Despite the foregoing, a drawback of zero-shot neural architecture search is that such metrics may not be accurate in distinguishing good model candidates. Additionally, the metrics are task dependent, and, as a result, some metrics are more accurate than other metrics for different tasks.

Considering the foregoing approaches, a user may have a pre-trained model and may want to execute the model on a custom hardware accelerator and use custom compiler optimizations. The pre-trained model may have been designed without considering or knowing the specific properties of the hardware accelerator or compiler. As a result, there may exist more optimal models to the original pre-trained model that may be able to achieve superior runtimes, while having similar or better accuracy than the pre-trained model. Manually searching for alternative modules typically comes at a significant computational cost and engineering effort. Additionally, current techniques use pre-set search spaces that lack the ability to automatically update the search space. Furthermore, current techniques are focused on changing the entire model itself instead of only a portion of the model.

Embodiments of the present disclosure involve utilizing an approach that utilizes intermediate neural architecture search, which may be implemented utilizing the following functionality. In certain embodiments, for example, the algorithm(s) supporting the functionality provided by the system 100 and methods may include searching for new modules from any number of repositories, such as online-accessible repositories, on a regular, periodic, or predetermined basis. As modules are located during the search, the system 100 may include forming a module collection for a search space. Notably, in certain embodiments, the repositories and search space do not need to be fixed, and, instead, can be dynamic and may change at any time, and are not limited to pre-defined sets of modules that are heuristically selected. In certain embodiments, the algorithm(s) supporting the system 100 may search for the relevant modules that are capable of performing or facilitating a specific task (e.g., image classification, object detection, image segmentation, content-based retrieval, or other tasks)

Once the modules are searched across repositories and in the search space, the system 100 may identify and select specific layers of the original pre-trained module that are good candidates for substitution. Additionally, insertion points and connections may be selected within the model that may serve as the location at which a new module or updated module may be inserted and connected to other modules of the model. In certain embodiments, neural architecture search may be utilized to search for a block of layers (i.e., including modules) and stack them multiple times to create the model. However, in certain preferred embodiments, the system 100 may aim to preserve parts of the original pre-trained model and modify specific layers of the model to improve and enhance the model. In certain embodiments, once the insertion points and connections are selected, the system 100 and methods may include applying a metric to conduct an initial ranking of the modules in the search space. The metric may indicate for example, a minimum specific accuracy level, a threshold amount of computer resources utilized by the module, a code size, types of data structures and/or objects utilized in a module, types of algorithms used in the module, any type of metric, or a combination thereof. In certain embodiments, it may be assumed that only changes to the selected layers may be conducted and that the ranked modules are candidates for substituting modules in the selected layers.

In certain embodiments, the system 100 and methods may include selecting the top-k candidate modules and training them using intermediate features distillation for a few epochs on a distribution of the data associated with the task (i.e., instead of having to use the data itself) based on accuracy. This may be conducted in order to have a better final accuracy prediction for the module and/or model including the module. During distillation, the system 100 and methods may include utilizing a teacher module that is pre-trained and a student module that learns from the teacher module. While giving the same input to both the teacher module and the student module, the output from the teacher module (e.g., soft labels) may be used as labels to train the student module. Using the framework provided by the present disclosure, only the input and output features of the modules may be used to transfer from teacher module to student module. This may be in contrast to having to fully train the entire model itself. In certain embodiments, the modules that train faster and/or have higher accuracy for performing the task may be ranked higher by the system 100 and methods.

Once the intermediate features distillation is conducted, the top-k candidate modules (or models) may be executed on a deep learning accelerator to obtain the runtime execution for that specific deep learning accelerator for each of the candidate modules (or models). In certain embodiments, the process conducted by the system 100 may account for compiler and hardware optimizations on the final runtime when choosing the final model including the modules. In certain embodiments, when it comes to selecting modules for insertion into the insertion point of the original model, the system 100 may include selection of the modules based on examining both the accuracy rank and the runtime execution rank. In certain embodiments, the system 100 may select a module(s) based on a pareto optima between the accuracy rank and the runtime rank and insert the module(s) at the insertion point(s) of the original model accordingly. The result is an updated or optimal proposed model that may be utilized to perform the task at hand. In certain embodiments, the optimal proposed model may be fine-tined using distillation as well. As modules get updated and/or new models are included into the repositories and ultimately the search space, the optimal model may be further tuned to provide an even more optimal model.

In an exemplary embodiment, a system for providing intermediate neural architecture search may be provided. The system may include a memory and a processor. In certain embodiments, the processor may be configured to search, by utilizing a neural network, for a plurality of modules for inclusion in a module collection of a search space. The processor may be configured to determine, by utilizing the neural network, an insertion point within an existing artificial intelligence model. The processor may be configured to apply a metric to the plurality of modules in the module collection. The processor may be configured to generate, based on the metric, a ranking of candidate modules of the plurality of modules for substituting an existing module located at the insertion point within the existing artificial intelligence model. The processor may be configured to train the candidate modules using intermediate features distillation over a period of time on a distribution of data associated with a dataset. The processor may be configured to determine, based on the training, an accuracy rank for each of the candidate modules. The processor may be configured to facilitate execution of candidate models including the candidate modules on a deep learning accelerator to determine a runtime execution rank for each of the candidate models. Furthermore, the processor may be configured to determine an optimal proposed model from the candidate models based on the accuracy rank and the runtime execution rank.

In certain embodiments, the processor may be configured to conduct an artificial intelligence task by utilizing the optimal proposed model. In certain embodiments, the processor may be further configured to determine the optimal proposed model from the candidate models based on determining a pareto optima between the accuracy rank and the runtime execution rank. In certain embodiments, the processor may be further configured to utilize a teacher model and a student model during the intermediate features distillation. In certain embodiments, the processor may be further configured to utilize a same input to both the teacher model and the student model, the input comprising features of the candidate modules. The processor may further be configured to utilize an output of the teacher model as a soft label to train the student model. In certain embodiments, the processor may be further configured to identify the candidate modules from the plurality of modules in the module collection of the search space based on a type of a task to be performed. In certain embodiments, the processor may be further configured to determine whether the plurality of modules in the search space have been updated, new modules have been included in the search space, or a combination thereof.

In certain embodiments, the processor may be further configured to determine an insertion point within the optimal proposed model for potential substitution with an updated module of the plurality of modules or a new module of the new modules of the search space. In certain embodiments, the processor may be further configured to generate a ranking of new candidate modules to substitute a module of the optimal proposed model based on application of a metric to the updated module, the new module, or a combination thereof. In certain embodiments, the processor may be further configured to determine an accuracy rank for the new candidate modules based on training the new candidate modules for a period of time and execute new candidate models including the new candidate modules on the deep learning accelerator to determine a runtime execution rank for each of the new candidate models. In certain embodiments, the processor may be configured to determine a new optimal proposed model based on the accuracy rank for the new candidate modules and the runtime execution rank for each of the new candidate models. In certain embodiments, the processor may be further configured to identify layers of the existing artificial intelligence model as candidates for substitution. In certain embodiments, the processor may be further configured to generate the optimal proposed model from the existing artificial intelligence model.

In exemplary embodiments, a method for providing intermediate neural architecture search is provided. The method may include searching, by utilizing a neural network, for a plurality of modules for inclusion in a module collection of a search space. Additionally the method may include determining, by utilizing the neural network, an insertion point within an existing artificial intelligence model. The method may include applying a metric to the plurality of modules in the module collection. The method may include generating, based on the metric, a ranking of candidate modules of the plurality of modules for substituting an existing module located at the insertion point within the existing artificial intelligence model. The method may include training the candidate modules using intermediate features distillation over a period of time on a distribution of data associated with a dataset. The method may include determining, based on the training, an accuracy rank for each of the candidate modules. The method may include executing candidate models including the candidate modules on a deep learning accelerator to determine a runtime execution rank for each of the candidate models. The method may include determining an optimal proposed model from the candidate models based on the accuracy rank and the runtime execution rank.

In certain embodiments, the method may include preserving a portion of the existing artificial intelligence model in the optimal proposed model. In certain embodiments, the method may include dynamically adjusting the optimal proposed model in real-time as the plurality of modules in the module collection of the search space change. In certain embodiments, the method may include training each candidate module using intermediate features distillation without training an entirety of the candidate model including each candidate module. In certain embodiments, the method may include identifying at least one block of the existing artificial intelligence model to substitute based on a characteristic of a dataset for training the existing artificial intelligence model, a characteristic of a task to be completed by the existing artificial intelligence model, a characteristic of the deep learning accelerator, or a combination thereof. In certain embodiments, the method may include identifying a top-k set of candidate models of the candidate models for execution on the deep learning accelerator.

In further exemplary embodiments, a device, such as a memory device or integrated circuit, for providing intermediate neural architecture search is provided. The device may include a memory and a processor or controller. The device may be configured to search, by utilizing a neural network, for a plurality of modules for inclusion in a module collection of a search space. The device may be configured to determine, by utilizing the neural network, an insertion point within an existing artificial intelligence model. The device may be configured to generate, based on application of a metric to the plurality of modules in the module collection, a ranking of candidate modules of the plurality of modules for substituting an existing module located at the insertion point within the existing artificial intelligence model. The device may be configured to train the candidate modules using intermediate features distillation over a period of time on a distribution of data associated with a dataset. The device may be configured to determine, based on the training, an accuracy rank for each of the candidate modules. The device may be configured to facilitate execution of candidate models including the candidate modules on a deep learning accelerator to determine a runtime execution rank for each of the candidate models. The device may be configured to determine an optimal proposed model from the candidate models based on the accuracy rank and the runtime execution rank. The device may be configured to execute a task using the optimal proposed model.

Based on the functionality and operative features provided by the system 100 and methods, the use of intermediate features distillation may be utilized to transfer knowledge between modules on relatively few epochs. By doing so, this avoids the use of user data and avoids training the whole entire model when searching for an alternative model/module. Additionally, the use of intermediate metrics between one-shot and zero-shot neural architecture search may be utilized to avoid training costs. Furthermore, runtime may be utilized to propose hardware and compiler aware module alternatives, while also providing similar or better accuracy and better model inference runtime. Moreover, the use of programs to search and collect modules to provide a continuous search space update to keep modules suggestions relevant even if a new module is created. Still further, the use of automated flows to search for alternative neural network architectures is provided herewith and such automation reduces engineering effort.

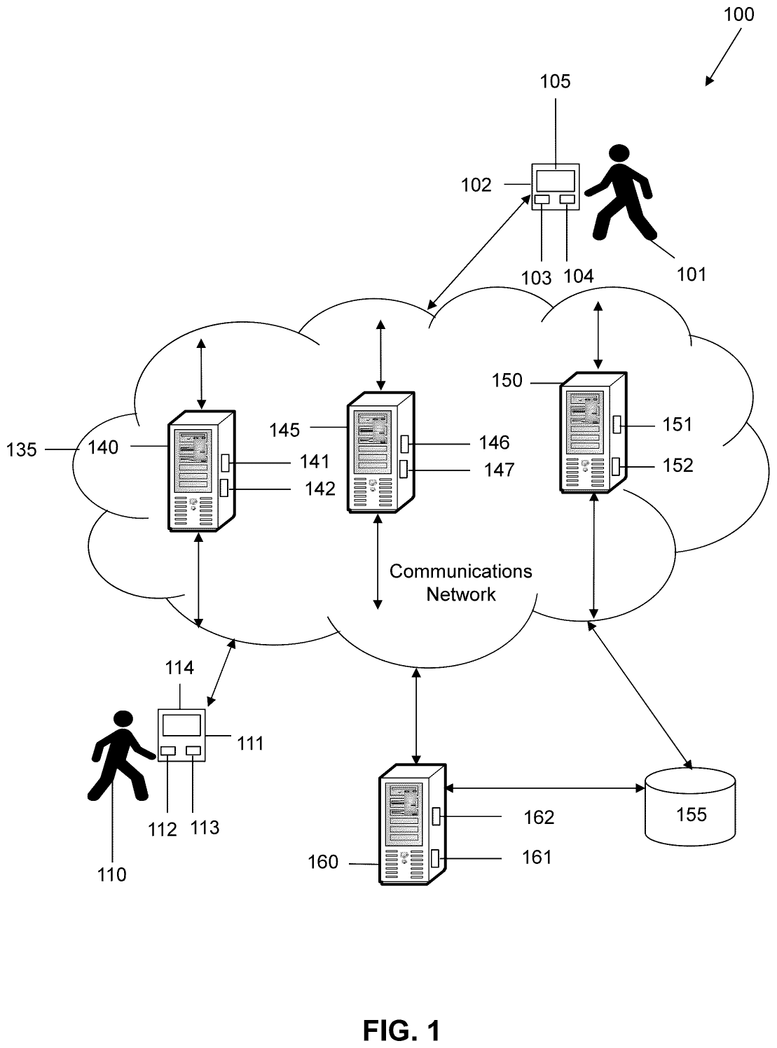

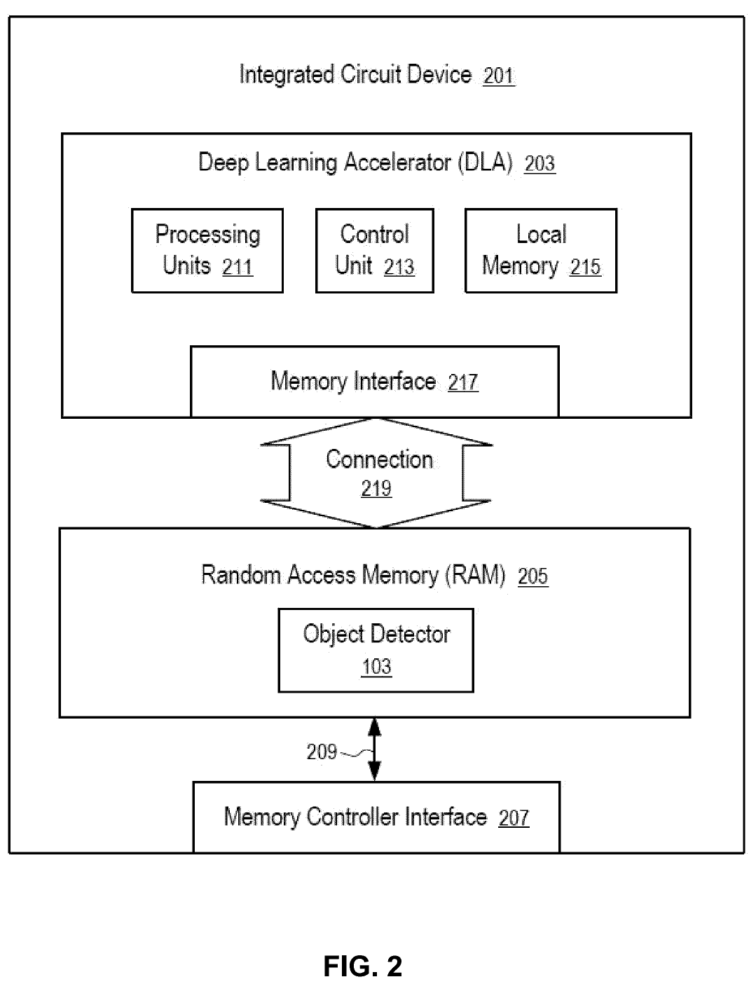

As shown in FIG. 1 and referring also to FIGS. 2-10, a system 100 for providing intermediate module neural architecture search is provided. Notably, the system 100 may be configured to support, but is not limited to supporting, neural architecture search, data analytics systems and services, data collation and processing systems and services, artificial intelligence services and systems, machine learning services and systems, neural network services, vision transformer-based services, convolutional neural network (CNN)-based services, security systems and services, surveillance and monitoring systems and services, autonomous vehicle applications and services, mobile applications and services, alert systems and services, content delivery services, cloud computing services, satellite services, telephone services, voice-over-internet protocol services (VOIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized to access an application, devices, and/or components of the system 100 that provide any or all of the operative functions of the system 100. In certain embodiments, the first user 101 may be a person, a robot, a humanoid, a program, a computer, any type of user, or a combination thereof, that may be located in a particular environment. In certain embodiments, the first user 101 may be a person that may want to utilize the first user device 102 to conduct various types of artificial intelligence tasks by utilizing neural networks. For example, such tasks may be computer vision tasks, such as, but not limited to, image classification, object detection, image segmentation, among other computer vision tasks. For example, the first user 101 may seek to identify objects existing within an environment and the first user 101 may take images and/or video content of the environment, which may be processed by utilizing neural networks accessible by the first user device 102.

The first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, an autonomous vehicle, and/or any other type of computing device. Illustratively, the first user device 102 is shown as a smartphone device in FIG. 1. In certain embodiments, the first user device 102 may be utilized by the first user 101 to control and/or provide some or all of the operative functionality of the system 100.

In addition to using first user device 102, the first user 101 may also utilize and/or have access to additional user devices. As with first user device 102, the first user 101 may utilize the additional user devices to transmit signals to access various online services and content, record various content, and/or access functionality provided by one or more neural networks. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, humidity sensors, any type of sensors, or a combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information relating to the various components of the user devices, information associated with images and/or content accessed and/or recorded by a user of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network, information identifying devices being added to or removed from the communications network, any other information, or any combination thereof.

In addition to the first user 101, the system 100 may also include a second user 110. The second user 110 may be similar to the first user 101, but may seek to do image classification, segmentation, and/or other computer vision-related tasks in a different environment and/or with a different user device, such as second user device 111. In certain embodiments, the second user device 111 may be utilized by the second user 110 to transmit signals to request various types of content, services, and data provided by and/or accessible by communications network 135 or any other network in the system 100. In further embodiments, the second user 110 may be a robot, a computer, a vehicle (e.g. semi or fully-automated vehicle), a humanoid, an animal, any type of user, or any combination thereof. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, an autonomous vehicle, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, humidity sensors, any type of sensors, or a combination thereof.

In certain embodiments, the first user device 102, the additional user devices, and/or the second user device 111 may have any number of software functions, applications and/or application services stored and/or accessible thereon. For example, the first user device 102, the additional user devices, and/or the second user device 111 may include applications for controlling and/or accessing the operative features and functionality of the system 100, applications for accessing and/or utilizing neural networks of the system 100, applications for controlling and/or accessing any device of the system 100, neural architecture search applications, interactive social media applications, biometric applications, cloud-based applications, VOIP applications, other types of phone-based applications, product-ordering applications, business applications, c-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 110 to readily interact with the software applications. The software applications and services may also be utilized by the first and/or second users 101, 110 to interact with any device in the system 100, any network in the system 100, or any combination thereof. In certain embodiments, the first user device 102, the additional user devices, and/or potentially the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, the first user 101, any other designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VOLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, the second user device 111, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 110, store modules, store layers, store blocks, store runtime execution values, store accuracy values relating to the modules, store information relating to tasks to be performed by models and/or modules, store artificial intelligence/neural network models utilized in the system 100, store sensor data and/or content obtained from an environment, store predictions made by the system 100 and/or artificial intelligence/neural network models, storing confidence scores relating to predictions made, store threshold values for confidence scores, responses outputted and/or facilitated by the system 100 and, store information associated with anything detected via the system 100, store information and/or content utilized to train the artificial intelligence/neural network models, store user profiles associated with the first and second users 101, 110, store device profiles associated with any device in the system 100, store communications traversing the system 100, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

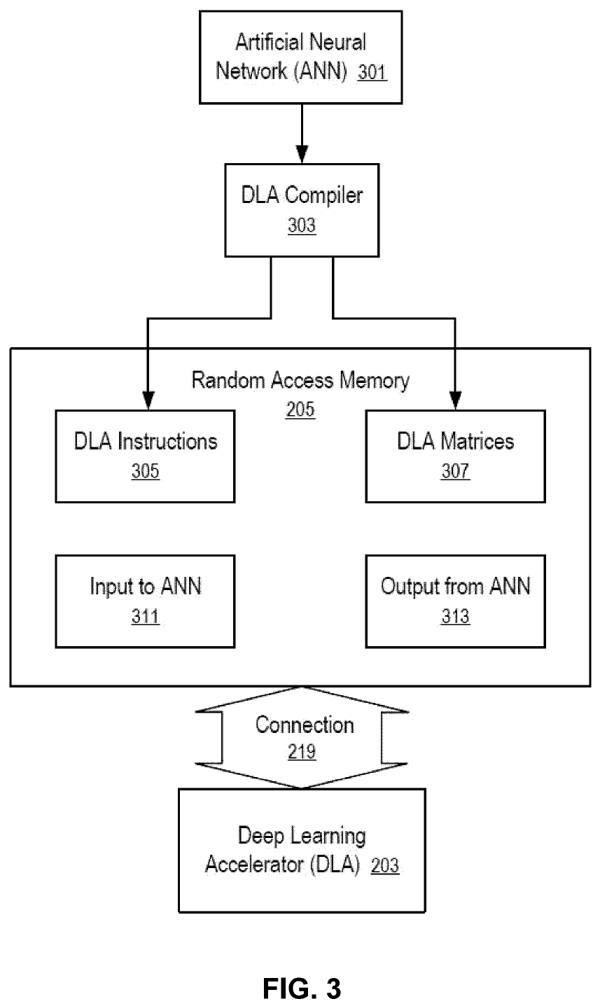

Referring now also to FIG. 2, an exemplary integrated circuit device 201 and accompanying componentry that may be utilized by a neural network, modules, and models of the present disclosure to provide intermediate neural architecture search is provided. In certain embodiments, the integrated circuit device 201 may include a deep learning accelerator 203 and a memory 205 (e.g., random access memory or other memory). In certain embodiments, the deep learning accelerator 203 may be hardware and may have specifications and features designed to accelerate artificial intelligence and machine learning processes and enhance performance of artificial intelligence models and modules contained therein. In certain embodiments, the deep learning accelerator 203 may be configured to accelerate deep learning workloads and computations. In certain embodiments, the memory 205 may include an object detector 103. For example, the object detector 103 may include a neural network structure. In certain embodiments, a description of the object detector 103 may be compiled by a compiler to generate instructions for execution by the deep learning accelerator 203 and matrices to be used by the instructions. In certain embodiments, the object detector 103 in the memory 205 may include the instructions 305 and the matrices 307 generated by the compiler 303, as further discussed below in connection with FIG. 3. In certain embodiments, the deep learning accelerator 203 may include processing units 211, a control unit 213, and local memory 215. When vector and matrix operands are in the local memory 215, the control unit 213 may use the processing units 211 to perform vector and matrix operations in accordance with instructions. In certain embodiments, the control unit 213 can load instructions and operands from the memory 205 through a memory interface 217 and a high speed bandwidth connection 219.

In certain embodiments, the integrated circuit device 201 may be configured to be enclosed within an integrated circuit package with pins or contacts for a memory controller interface 207. In certain embodiments, the memory controller interface 207 may be configured to support a standard memory access protocol such that the integrated circuit device 201 appears to a typical memory controller in a way same as a conventional random access memory device having no deep learning accelerator 203. For example, a memory controller external to the integrated circuit device 201 may access, using a standard memory access protocol through the memory controller interface 207, the memory 205 in the integrated circuit device 201. In certain embodiments, the integrated circuit device 201 may be configured with a high bandwidth connection 219 between the memory 205 and the deep learning accelerator 203 that are enclosed within the integrated circuit device 201. In certain embodiments, bandwidth of the connection 219 is higher than the bandwidth of the connection 209 between the random access memory 205 and the memory controller interface 207.

In certain embodiments, both the memory controller interface 207 and the memory interface 217 may be configured to access the memory 205 via a same set of buses or wires. In certain embodiments, the bandwidth to access the memory 205 may be shared between the memory interface 217 and the memory controller interface 207. In certain embodiments, the memory controller interface 207 and the memory interface 217 may be configured to access the memory 205 via separate sets of buses or wires. In certain embodiments, the memory 205 may include multiple sections that can be accessed concurrently via the connection 219. For example, when the memory interface 217 is accessing a section of the memory 205, the memory controller interface 207 may concurrently access another section of the memory 205. For example, the different sections can be configured on different integrated circuit dies and/or different planes/banks of memory cells; and the different sections can be accessed in parallel to increase throughput in accessing the memory 205. For example, the memory controller interface 207 may be configured to access one data unit of a predetermined size at a time; and the memory interface 217 is configured to access multiple data units, each of the same predetermined size, at a time.

In certain embodiments, the memory 205 and the integrated circuit device 201 may be configured on different integrated circuit dies configured within a same integrated circuit package. In certain embodiments, the memory 205 may be configured on one or more integrated circuit dies that allows parallel access of multiple data elements concurrently. In certain embodiments, the number of data elements of a vector or matrix that may be accessed in parallel over the connection 219 corresponds to the granularity of the deep learning accelerator operating on vectors or matrices. For example, when the processing units 211 may operate on a number of vector/matrix elements in parallel, the connection 219 may be configured to load or store the same number, or multiples of the number, of elements via the connection 219 in parallel. In certain embodiments, the data access speed of the connection 219 may be configured based on the processing speed of the deep learning accelerator 203. For example, after an amount of data and instructions have been loaded into the local memory 215, the control unit 213 may execute an instruction to operate on the data using the processing units 211 to generate output. Within the time period of processing to generate the output, the access bandwidth of the connection 219 may allow the same amount of data and instructions to be loaded into the local memory 215 for the next operation and the same amount of output to be stored back to the random access memory 205. For example, while the control unit 213 is using a portion of the local memory 215 to process data and generate output, the memory interface 217 can offload the output of a prior operation into the random access memory 205 from, and load operand data and instructions into, another portion of the local memory 215. Thus, the utilization and performance of the deep learning accelerator 203 may not be restricted or reduced by the bandwidth of the connection 219.

In certain embodiments, the memory 205 may be used to store the model data of a neural network and to buffer input data for the neural network. The model data may include the output generated by a compiler for the deep learning accelerator 203 to implement the neural network. The model data may include matrices used in the description of the neural network and instructions generated for the deep learning accelerator 203 to perform vector/matrix operations of the neural network based on vector/matrix operations of the granularity of the deep learning accelerator 203. The instructions may operate not only on the vector/matrix operations of the neural network, but also on the input data for the neural network. In certain embodiments, when the input data is loaded or updated in the memory 205, the control unit 213 of the deep learning accelerator 203 may automatically execute the instructions for the neural network to generate an output for the neural network. The output may be stored into a predefined region in the memory 205. The deep learning accelerator 203 may execute the instructions without help from a central processing unit (CPU). Thus, communications for the coordination between the deep learning accelerator 203 and a processor outside of the integrated circuit device 201 (e.g., a Central Processing Unit (CPU)) can be reduced or eliminated.

In certain embodiments, the memory 205 can be volatile memory or non-volatile memory, or a combination of volatile memory and non-volatile memory. Examples of non-volatile memory include flash memory, memory cells formed based on negative-and (NAND) logic gates, negative-or (NOR) logic gates, Phase-Change Memory (PCM), magnetic memory (MRAM), resistive random-access memory, cross point storage and memory devices. A cross point memory device can use transistor-less memory elements, each of which has a memory cell and a selector that are stacked together as a column. Memory element columns are connected via two lays of wires running in perpendicular directions, where wires of one lay run in one direction in the layer that is located above the memory element columns, and wires of the other lay run in another direction and are located below the memory element columns. Each memory element can be individually selected at a cross point of one wire on each of the two layers. Cross point memory devices are fast and non-volatile and can be used as a unified memory pool for processing and storage. Further examples of non-volatile memory include Read-Only Memory (ROM), Programmable Read-Only Memory (PROM), Erasable Programmable Read-Only Memory (EPROM) and Electronically Erasable Programmable Read-Only Memory (EEPROM) memory, etc. Examples of volatile memory include Dynamic Random-Access Memory (DRAM) and Static Random-Access Memory (SRAM).

For example, non-volatile memory can be configured to implement at least a portion of the memory 205. The non-volatile memory in the memory 205 may be used to store the model data of a neural network. Thus, after the integrated circuit device 201 is powered off and restarts, it is not necessary to reload the model data of the neural network into the integrated circuit device 201. Further, the non-volatile memory may be programmable/rewritable. Thus, the model data of the neural network in the integrated circuit device 201 may be updated or replaced to implement an updated neural network or another neural network.

Referring now also to FIG. 3, an exemplary deep learning accelerator 203 and memory 205 configured to apply inputs to a trained artificial neural network for performing tasks is shown. In certain embodiments, an artificial neural network 301 may be trained through machine learning (e.g., deep learning) to implement an artificial intelligence model and modules included therein. A description of the trained artificial neural network 301 in a standard format may identify the properties of the artificial neurons and their connectivity. In certain embodiments, the compiler 303 may convert trained artificial neural network 301 by generating instructions 305 for a deep learning accelerator 203 and matrices 307 corresponding to the properties of the artificial neurons and their connectivity. In certain embodiments, the instructions 305 and the matrices 307 generated by the compiler 303 from the trained artificial neural network 301 may be stored in memory 205 for the deep learning accelerator 203. For example, the memory 205 and the deep learning accelerator 203 may be connected via a high bandwidth connection 219 in a way as in the integrated circuit device 201. The computations of the artificial neural network 301 may be based on the instructions 305 and the matrices 307 may be implemented in the integrated circuit device 201. In certain embodiments, the memory 205 and the deep learning accelerator 203 may be configured on a printed circuit board with multiple point to point serial buses running in parallel to implement the connection 219.

In certain embodiments, after the results of the compiler 303 are stored in the memory 205, the application of the trained artificial neural network 301 to process an input 311 to the trained artificial neural network 301 to generate the corresponding output 313 of the trained artificial neural network 301 may be triggered by the presence of the input 311 in the memory 205, or another indication provided in the memory 205. In response, the deep learning accelerator 203 executes the instructions 305 to combine the input 311 and the matrices 307. The matrices 307 may include kernel matrices to be loaded into kernel buffers and maps matrices to be loaded into maps banks. The execution of the instructions 305 can include the generation of maps matrices for the maps banks of one or more matrix-matrix units of the deep learning accelerator 203. In certain embodiments, the inputs to artificial neural network 301 is in the form of an initial maps matrix. Portions of the initial maps matrix can be retrieved from the memory 205 as the matrix operand stored in the maps banks of a matrix-matrix unit. In certain embodiments, the instructions 305 also include instructions for the deep learning accelerator 203 to generate the initial maps matrix from the input 311. Based on the instructions 305, the deep learning accelerator 203 may load matrix operands into kernel buffers and maps banks of its matrix-matrix unit. The matrix-matrix unit performs the matrix computation on the matrix operands. For example, the instructions 305 break down matrix computations of the trained artificial neural network 301 according to the computation granularity of the deep learning accelerator 203 (e.g., the sizes/dimensions of matrices that loaded as matrix operands in the matrix-matrix unit) and applies the input feature maps to the kernel of a layer of artificial neurons to generate output as the input for the next layer of artificial neurons.

Upon completion of the computation of the trained artificial neural network 301 performed according to the instructions 305, the deep learning accelerator 203 may store the output 313 of the artificial neural network 301 at a pre-defined location in the memory 205, or at a location specified in an indication provided in the memory 205 to trigger the computation. In certain embodiments, an external device connected to the memory controller interface 207 can write the input 311 (e.g., an image) into the memory 205 and trigger the computation of applying the input 311 to the trained artificial neural network 301 by the deep learning accelerator 203. After a period of time, the output 313 (e.g., a classification) is available in the memory 205 and the external device can read the output 313 via the memory controller interface 207 of the integrated circuit device 201. For example, a predefined location in the memory 205 can be configured to store an indication to trigger the execution of the instructions 305 by the deep learning accelerator 203. The indication can include a location of the input 311 within the memory 205. Thus, during the execution of the instructions 305 to process the input 311, the external device can retrieve the output generated during a previous run of the instructions 305, and/or store another set of input for the next run of the instructions 305.

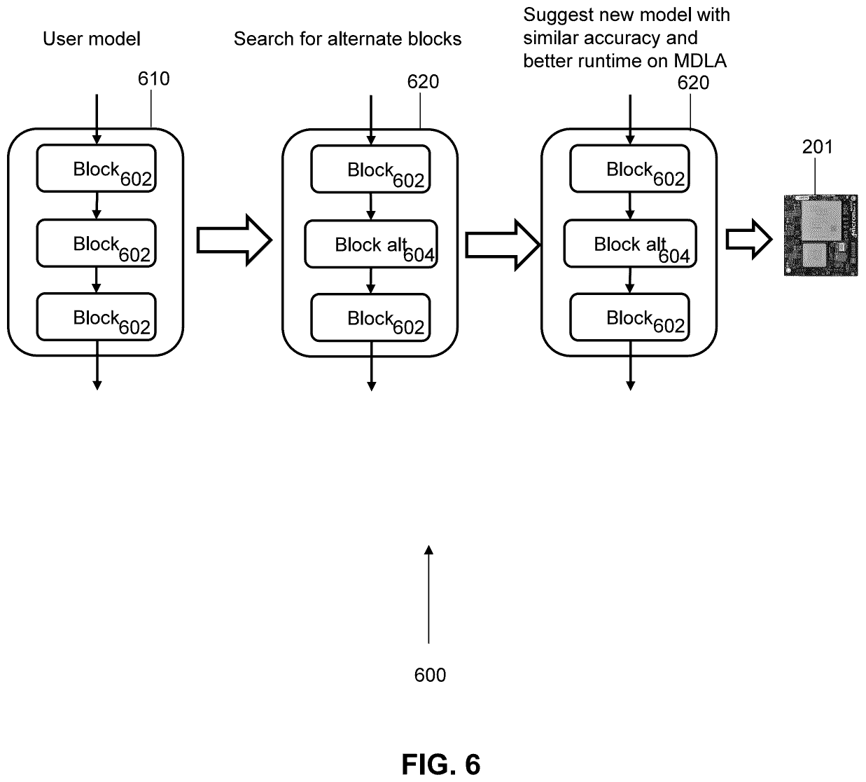

Referring now also to FIG. 6, an example illustrating intermediate neural architecture search according to embodiments of the present disclosure is schematically illustrated. FIG. 6, for example, illustrates an exemplary pre-trained user model 610 that may include any number of blocks 602 (or layers), which may each include any number of modules supporting the operative functionality of the module 610. Utilize the operative functionality of the system 100, the system 100, such as by utilizing a neural network, may search for alternate blocks to substitute one or more of the blocks 602. For example, an alternate block 604 may be located via online repositories and/or a search space to replace the middle block 602 shown in FIG. 6. The processes of the present disclosure may be executed to determine accuracy ranks for the located blocks (or modules) and runtime ranks based on execution on a deep learning accelerator 203 of an integrated circuit 201. In certain embodiments, the pareto optima between the accuracy and runtime ranks may be selected and the module and/or block may be substituted in place of middle block 602 by using block 604 that includes a higher performing module, thereby resulting in an optimized model 620 for performing a particular task, such as a computer vision task.

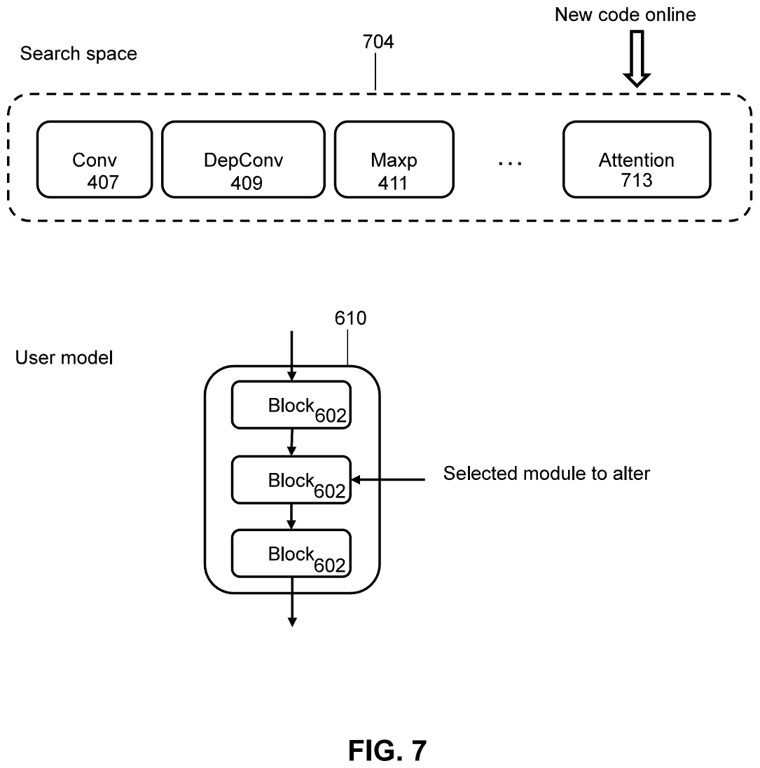

Referring now also to FIGS. 7, 8, 9, and 10, further details relating to the process of intermediate neural architecture search as schematically shown. The system 100 may search for new or updated modules and/or code from a plurality of repositories. Possible modules for substituting one or more modules in a user model 610 may be grouped into a module collection within a search space 704. For example, the modules may be a convolutional module 407, a depth separable module 409, a max pooling module 411, an attention module 713, any other modules, or a combination thereof. In certain embodiments, the system 100 may determine that the middle block 602 of user model 610 of FIG. 7 takes a disproportionate amount of computing resources when compared to the top and bottom blocks 602, and, as a result, would be a good candidate for substitution with a new or updated block containing a new or updated module. The system may set that block/layer as the choice block 804 for potential substitution and as the insertion point for the new module(s) and block.

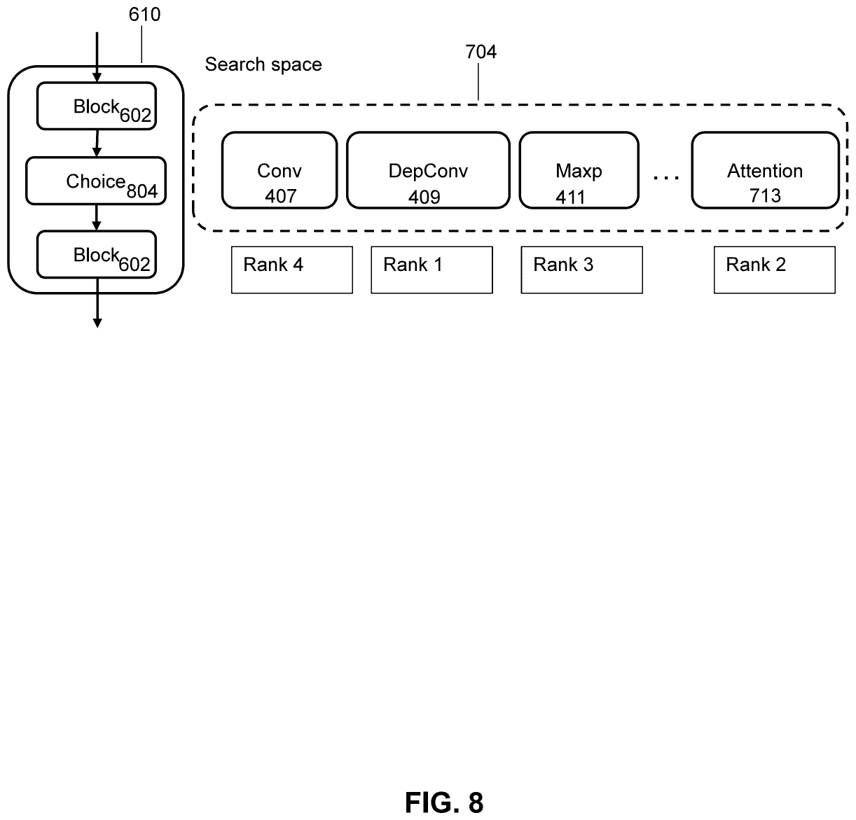

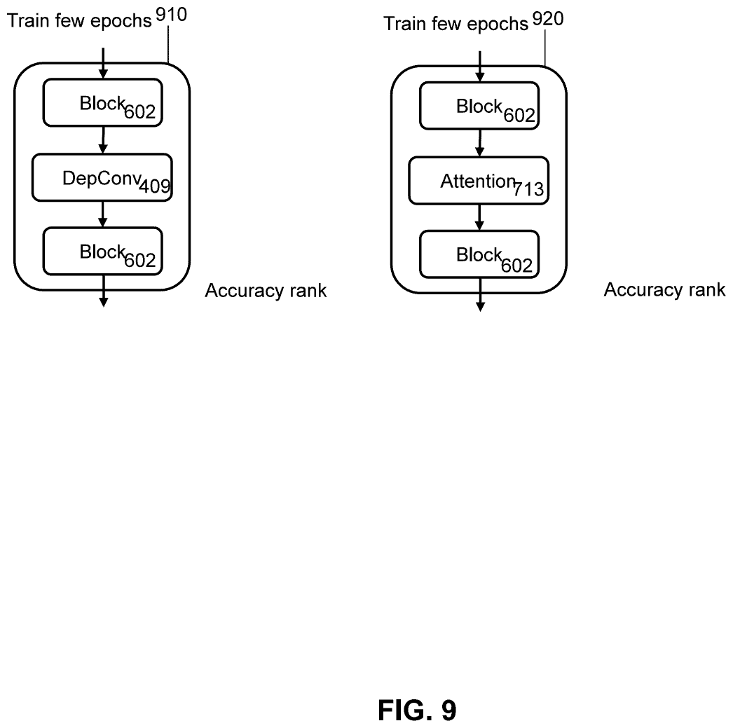

In certain embodiments, as shown in FIG. 8, a metric (e.g. zero-shot metric) may be applied to the modules in the collection to determine an initial ranking of the modules in the collection. For example, as shown in FIG. 8, the depth separate module 409 may be ranked 1, the attention module 713 may be ranked 2, the max pooling module 411 may be ranked 3, and the convolutional layer 407 may be ranked 4. Then, the system 100 may determine accuracy ranks for each of the preliminarily ranked modules by conducting intermediate module distillation, which may involve utilizing teacher modules to train student modules without having to train the entire model itself. The intermediate module distillation may be utilized to determine accuracy ranks for each of the modules. For example, system 100 may select the top k (e.g., in this case 2) modules for participating in the distillation. As shown in FIG. 9 and using the prior rankings, the attention module 713 may be substituted in the middle block 602 to make a model 920 and the depth separable module 409 may be substituted in the middle block 602 to make a model 910. The distillation may determine the accuracy rank based on which module trains faster and provides greater accuracy.

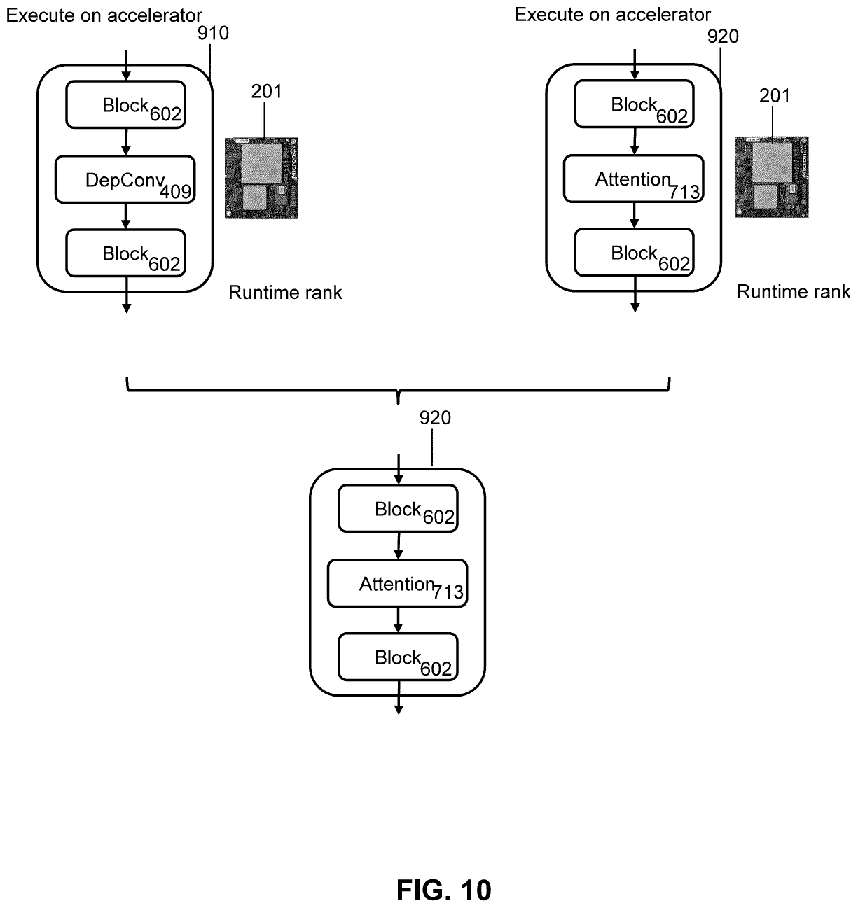

Then, as shown in FIG. 10, the system 100 may run the top-k candidate models (or modules) on the deep learning accelerator 203 of the integrated circuit 201 to determine the runtime execution for the candidate models (or modules). In certain embodiments, the pareto optima between the accuracy rank and the runtime rank may be the module selected for substitution. For example, in FIG. 10, the attention module 713 may be selected and substituted into the middle block 602/choice block 804 to create an optimal proposed model 920 that may be configured to perform an artificial intelligence task with at least the same or better accuracy as the original user model, while also having superior run time. The process may be repeated as desired as new and/or updated modules are available in the repositories.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, searching repositories and search spaces for modules; determining insertion points within an existing artificial intelligence model for new modules to be inserted; applying metrics to modules in a search space to generate a ranking of candidate modules for potential substitution of an existing module in the existing artificial intelligence model; training candidate modules using intermediate distillation over a period of time; determining accuracy ranks for the candidate modules based on the training results; executing candidate models including the candidate modules on a deep learning accelerator to determine a runtime execution rank for each of the candidate models; determining an optimal proposed model from the candidate models based on the accuracy rank, the runtime execution rank, or a combination thereof; performing tasks using the optimal model; determining whether updated modules or new models are in the repositories and/or search space; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIGS. 1-12 illustrates specific example configurations of the various components of the system 100, the system 100 may include any configuration of the components, which may include using a greater or lesser number of the components. For example, the system 100 is illustratively shown as including a first user device 102, a second user device 111, a communications network 135, a server 140, a server 145, a server 150, a server 160, and a database 155. However, the system 100 may include multiple first user devices 102, multiple second user devices 111, multiple communications networks 135, multiple servers 140, multiple servers 145, multiple servers 150, multiple servers 160, multiple databases 155, and/or any number of any of the other components inside or outside the system 100. Similarly, the system 100 may include any number of integrated circuits 201, deep learning accelerators 203, search spaces, layers, blocks, modules, models, repositories, or a combination thereof. Furthermore, in certain embodiments, substantial portions of the functionality and operations of the system 100 may be performed by other networks and systems that may be connected to system 100.

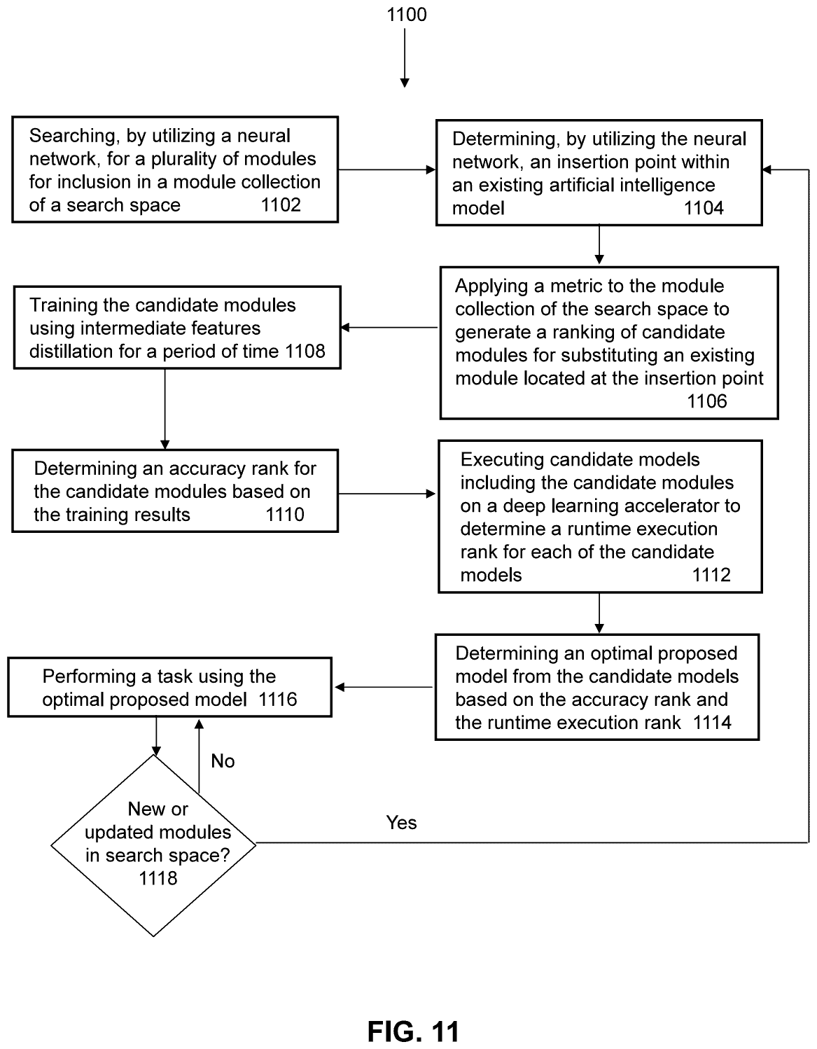

Referring now also to FIG. 11, FIG. 11 illustrates a method 1100 for providing intermediate module neural architecture search according to embodiments of the present disclosure. For example, the method of FIG. 11 can be implemented in the system of FIG. 1 and/or any of the other systems, devices, and/or componentry illustrated in the Figures. In certain embodiments, the method of FIG. 11 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 11 may be performed at least in part by one or more processing devices (e.g., processor 102, processor 112, processor 141, processor 146, processor 151, and processor 161 of FIG. 1). Although shown in a particular sequence or order, unless otherwise specified, the order of the steps in the method 1100 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 1100 may include steps for utilizing intermediate neural architecture search in a neural network to optimize artificial intelligence models to enhance performance of tasks, such as, but not limited to, artificial-intelligence-related tasks (e.g., computer vision, pattern matching, robot control, speech analysis, perception, natural language processing, reasoning, inference, among other tasks). In certain embodiments, the method 1100 may provide a framework that receives a user pre-trained model and outputs an optimized model based of the original user pre-trained model that achieves similar or better accuracy, while simultaneously executing faster on a deep learning accelerator. In certain embodiments, the method 1100 (e.g., first user 101) utilize a data distribution for a dataset to generate the optimized model without having to utilize the entire actual dataset itself for the task that the original model was trained for. In certain embodiments, the method 1100 may be performed by utilizing system 100, and/or by utilizing any combination of the componentry contained therein and any other systems and devices described herein. At step 1102, the method 1100 may include searching, such as by utilizing a neural network, for a plurality of modules (and models if desired) for inclusion in a module collection of a search space. In certain embodiments, the searching, for example, may be over any number of online repositories that are configured to store modules and/or models for use by the public (e.g., GitHub and other online repositories). In certain embodiments, the modules may be located on websites, databases, computer systems, computing devices, mobile devices, programs, files, any location connected to internet services, or a combination thereof. For example, the neural network may search for modules that may be utilized for CNNs, ViTs, deep learning models, and/or other artificial intelligence models to conduct tasks, such as, but not limited to computer vision or other tasks. As an example, computer vision tasks may include, but are not limited to, image classification (e.g., extracting features from image content and classifying and/or predicting the class of the image), object detection (e.g., identifying a certain class of image and then detect the presence of the image within image content), object tracking (e.g., tracking an object within an environment or media content once the object is detected), and content-based image retrieval (e.g., searching databases for content having similarity and/or correlation to content processed by the neural network), among other computer vision tasks.

In certain embodiments, the algorithms supporting the functionality of the system 100 may locate modules from repositories based on the relevance and/or characteristics of the module to performing a particular task. For example, if the task is a computer vision task, the system 100 may locate modules that may be utilized to optimize image detection or image classification, for example. The system 100 may analyze the characteristics, features, data structures, code, and/or other aspects of a module and compare them to the characteristics of a task to determine the relevance and/or matching of the module for the task. In certain embodiments, the modules may be located and/or identified based on the ability for the module to contribute to accuracy of a task and/or based on the impact that the functionality of the module has on execution runtime of the module and/or model within which the module would reside. Additionally, the search space and the repositories may be dynamic in that modules may be added, updated, modified, and/or removed from the search space and/or repositories on a regular basis. The search space and/or the repositories may be searched continuously, at periodic intervals, at random times, or at specific times. In certain embodiments, the searching for the plurality of modules for inclusion in the search space may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1104, the method 1100 may include determining, such as by utilizing the neural network, an insertion point within an existing artificial intelligence model. For example, the insertion point may correspond with a layer, module, block, or other component of the existing artificial intelligence model that may be a candidate for optimization with a replacement or substitute layer, module, block, or other component that may enable the model as a whole to perform more efficiently and/or accurately during performance of a task. In certain embodiments, a layer, block, module, or other component may be a candidate for substitution or replacement if the current layer, block module, or other component has a threshold level of impact on execution runtime of the model when performing a tasks, uses a threshold amount of computing resources, contributes to accuracy of performance of the tasks, is identified as critical for performance of the task, is identified as not being optimized, is identified as having possible replacements, is identified as taking a threshold amount of time to perform tasks, has a threshold amount of workload during performance of a tasks, has a greater number of activations than other layers, modules, blocks, and/or components of the model, or a combination thereof.

In certain embodiments, artificial intelligence algorithms supporting the functionality of the neural network may be utilized to select not only insertion points, but also connections (e.g. connections to modules within a model, connections to programs, any type of connections, or a combination thereof). In certain embodiments, the artificial intelligence algorithms may seek to only select certain layers, modules, blocks, or other components for substitution rather than the entire model. A model, for example, may include any number of modules, which together may be configured to perform the operative functionality of the model. The algorithms may do so to preserve as many characteristics and features of the original model as possible, while also seeking to finely tune the performance of the model by substituting portions of model instead of the entire model. In certain embodiments, the determining may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1106, the method 1100 may include applying a metric to the module collection of the search space to generate a ranking of candidate modules that may be potentially utilized to substitute an existing module located at the insertion point of the existing model. In certain embodiments, the metric may be a zero-shot metric that may be applied, such as when changes in selected layers or blocks of the existing model are to be modified. In certain embodiments, the metric may specify a specific execution runtime that the module must or should have to be a candidate module for substitution into the existing model, a level of accuracy for performing a particular task, a certain type of algorithm that is needed to perform a particular type of task, a type of deep learning accelerator that the module needs to be compatible with, an efficiency of the module in completing the type of task or a portion of the task, any other metric, or a combination thereof. In certain embodiments, the zero-shot metric may be utilized to ascertain a module's capability of learning how to perform the task without the use of training data to train the module. In certain embodiments, the application of the metric may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1108, the method 1100 may include training the candidate modules using intermediate features distillation over a period of time. In certain embodiments, the training may be conducted for a few epochs on a distribution of the data (i.e., rather then the actual dataset itself) that was utilized to train the original existing artificial intelligence model. In certain embodiments, during the distillation process, the system 100 may provide a teacher module that is pre-trained from the original existing artificial intelligence model and a student module that learns from the teacher module. While giving the same input to both teacher and student module, the output from the teacher module (i.e., soft labels) may be utilized as labels to train the student module. In the framework provided by the present disclosure, in certain embodiments, only the input and output features of the modules may be used to transfer learning form the teacher module to the student module. In certain embodiments, the foregoing may be in contrast to fully training the entire model. In certain embodiments, the modules that train faster may be ranked higher by the system 100. In certain embodiments, the training may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1110, the method 1100 may include determining an accuracy rank for the candidate modules based on the training results generated from the training. In certain embodiments, each module may be ranked based on its corresponding accuracy achieved to perform a given task. In certain embodiments, the determining of the accuracy rank for each of the candidate modules may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device. At step 1112, the method 1100 may include executing candidate models including the candidate modules on a deep learning accelerator to determine a runtime execution rank for each of the candidate models. In certain embodiments, the candidate modules may be executed instead of the entire candidate models. In certain embodiments, the executing may be performed and/or facilitated by utilizing the first user device 102, the second user device 111, the server 140, the server 145, the server 150, the server 160, the communications network 135, the integrated circuit device 201, the deep learning accelerator 203, any component of the system 100, any combination thereof, or by utilizing any other appropriate program, network, system, or device.

At step 1114, the method 1100 may include determining an optimal proposed model from the candidate models based on the accuracy ranks and the runtime execution ranks. In certain embodiments, the optimal proposed model include modules that having a highest combined accuracy and runtime execution rank. In certain embodiments, depending on the task to be performed by the model, the accuracy rank may be weighted higher than the runtime execution rank or vice versa. In certain embodiments, the determining of the optimal proposed model may be performed and/or facilitated by utilizing the first user device 102, the second user device 111, the server 140, the server 145, the server 150, the server 160, the communications network 135, the integrated circuit device 201, the deep learning accelerator 203, any component of the system 100, any combination thereof, or by utilizing any other appropriate program, network, system, or device. At step 1116, the method 1100 may include performing the task using the optimal proposed model. For example, if the task is a computer vision task, the computer vision task may be performed by utilizing the optimal proposed model. In certain embodiments, the performing of the task may be performed and/or facilitated by utilizing the first user device 102, the second user device 111, the server 140, the server 145, the server 150, the server 160, the communications network 135, the integrated circuit device 201, the deep learning accelerator 203, any component of the system 100, any combination thereof, or by utilizing any other appropriate program, network, system, or device.

At step 1118, the method 1100 may include determining whether new or updated modules are in the search space and/or in repositories. If not, the method 1100 may continue performing the task or subsequent tasks using the optimal model. If, however, new and/or updated models are in the search space, repositories, or a combination thereof, the method 1100 may proceed to step 1104 and continue the process again to create an optimized model based on the new models, updated models, or both. In certain embodiments, the method 1100 may be repeated as desired and/or by the system 100. Notably, the method 1100 may incorporate any of the other functionality as described herein and may be adapted to support the functionality of the system 100.

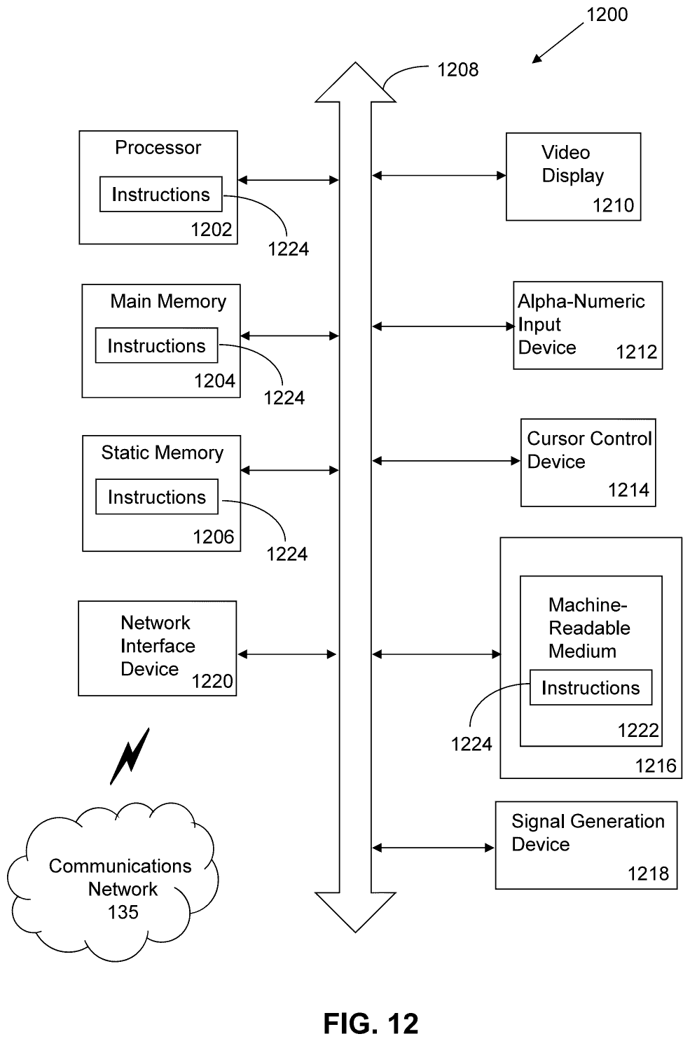

Referring now also to FIG. 12, at least a portion of the methodologies and techniques described with respect to the exemplary embodiments of the system 100 and/or method 1100 can incorporate a machine, such as, but not limited to, computer system 1200, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 1200 may assist in searching for a plurality of modules for inclusion in a module collection of a search space, determining insertion points in an existing model for potential replacement of modules located at the insertion point, applying metrics (e.g., zero-shot metrics or other metrics) to the module collection to generate rankings of candidate modules that may be utilized to replace existing modules located at the insertion point of the existing model, training candidate modules, such as by utilizing intermediate features distillation over a plurality of epochs, determining accuracy ranks for each candidate module, executing candidate models including the candidate modules on a deep learning accelerator to determine runtime execution ranks for the candidate models, determining an optimal proposed model from the candidate models based on the accuracy rank and the runtime execution rank, performing a task using the optimal proposed model (e.g., image classification, image segmentation, or other computer vision-related tasks), and/or performing any other operations of the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1200 may include a processor 1202 (e.g., a central processing unit (CPU), a graphics processing unit (GPU, or both), a main memory 1204 and a static memory 1206, which communicate with each other via a bus 1208. The computer system 1200 may further include a video display unit 1210, which may be, but is not limited to, a liquid crystal display (LCD), a flat panel, a solid-state display, or a cathode ray tube (CRT). The computer system 1200 may include an input device 1212, such as, but not limited to, a keyboard, a cursor control device 1214, such as, but not limited to, a mouse, a disk drive unit 1216, a signal generation device 1218, such as, but not limited to, a speaker or remote control, and a network interface device 1220.

The disk drive unit 1216 may include a machine-readable medium 1222 on which is stored one or more sets of instructions 1224, such as, but not limited to, software embodying any one or more of the methodologies or functions described herein, including those methods illustrated above. The instructions 1224 may also reside, completely or at least partially, within the main memory 1204, the static memory 1206, or within the processor 1202, or a combination thereof, during execution thereof by the computer system 1200. The main memory 1204 and the processor 1202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1222 containing instructions 1224 so that a device connected to the communications network 135, another network, or a combination thereof, can send or receive voice, video or data, and communicate over the communications network 135, another network, or a combination thereof, using the instructions. The instructions 1224 may further be transmitted or received over the communications network 135, another network, or a combination thereof, via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per sc. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
a memory; and
a processor, wherein the processor is configured to:
search, by utilizing a neural network, for a plurality of modules for inclusion in a module collection of a search space;
determine, by utilizing the neural network, an insertion point within an existing artificial intelligence model;
apply a metric to the plurality of modules in the module collection;
generate, based on the metric, a ranking of candidate modules of the plurality of modules for substituting an existing module located at the insertion point within the existing artificial intelligence model;
determine an accuracy rank for each of the candidate modules;
facilitate execution of candidate models including the candidate modules on a deep learning accelerator to determine a runtime execution rank for each of the candidate models; and
determine an optimal proposed model from the candidate models based on the accuracy rank and the runtime execution rank.

2. The system of claim 1, wherein the processor is further configured to:
train the candidate modules using intermediate features distillation over a period of time on a distribution of data associated with a dataset;
determine the accuracy rank for each of the candidate modules based on the training of the candidate modules; and
conduct an artificial intelligence task by utilizing the optimal proposed model.

3. The system of claim 1, wherein the processor is further configured to determine the optimal proposed model from the candidate models based on determining a pareto optima between the accuracy rank and the runtime execution rank.

4. The system of claim 1, wherein the processor is further configured to utilize a teacher model and a student model during intermediate features distillation conducted for training the candidate modules over a period of time on a distribution of data associated with a dataset.

5. The system of claim 4, wherein the processor is further configured to:
utilize a same input to both the teacher model and the student model, wherein the input comprises features of the candidate modules; and
utilize an output of the teacher model as a soft label to train the student model.

6. The system of claim 1, wherein the processor is further configured to identify the candidate modules from the plurality of modules in the module collection of the search space based on a type of a task to be performed.

7. The system of claim 1, wherein the processor is further configured to determine whether the plurality of modules in the search space have been updated, new modules have been included in the search space, or a combination thereof.

8. The system of claim 7, wherein the processor is further configured to determine an insertion point within the optimal proposed model for potential substitution with an updated module of the plurality of modules or a new module of the new modules of the search space.

9. The system of claim 8, wherein the processor is further configured to generate a ranking of new candidate modules to substitute a module of the optimal proposed model based on application of a metric to the updated module, the new module, or a combination thereof.

10. The system of claim 1, wherein the processor is further configured to:
determine an accuracy rank for the new candidate modules based on training the new candidate modules for a period of time; and
execute new candidate models including the new candidate modules on the deep learning accelerator to determine a runtime execution rank for each of the new candidate models.

11. The system of claim 10, wherein the processor is configured to determine a new optimal proposed model based on the accuracy rank for the new candidate modules and the runtime execution rank for each of the new candidate models.

12. The system of claim 1, wherein the processor is further configured to identify layers of the existing artificial intelligence model as candidates for substitution.

13. The system of claim 1, wherein the processor is further configured to generate the optimal proposed model from the existing artificial intelligence model.

14. A method, comprising:
identifying, by utilizing a neural network, a task to be completed;
identifying, based on a characteristic of the task, candidate modules of the plurality of modules in a repository for substituting at least a portion of a block within an existing artificial intelligence model;
training the candidate modules using intermediate features distillation on a distribution of data associated with a dataset;
determining, based on the training, an accuracy rank for each of the candidate modules;
executing candidate models including the candidate modules on a deep learning accelerator to determine a runtime execution rank for each of the candidate models;
determining an optimal proposed model from the candidate models based on the accuracy rank and the runtime execution rank, wherein the optimal proposed model includes a portion of the existing artificial intelligence model and includes a substitution of the portion of the block with a candidate module of the plurality of candidate modules.

15. The method of claim 14, further comprising executing the task by utilizing the optimal proposed model.

16. The method of claim 14, further comprising dynamically adjusting the optimal proposed model in real-time as the plurality of modules change.

17. The method of claim 14, further comprising training each candidate module using intermediate features distillation without training an entirety of the candidate model including each candidate module.

18. The method of claim 14, further comprising identifying the portion of the block of the existing artificial intelligence model to substitute based on a characteristic of a dataset for training the existing artificial intelligence model, a characteristic of the deep learning accelerator, or a combination thereof.

19. The method of claim 14, further comprising identifying a top-k set of candidate models of the candidate models for execution on the deep learning accelerator.

20. A device, comprising:
a memory; and
a processor;
wherein the processor is configured to search, by utilizing a neural network, for a plurality of modules in a plurality of repositories;
wherein the processor is configured to analyze first characteristics of the plurality of modules for inclusion in a search space;
selecting a set of candidate modules of the plurality of modules in the plurality of repositories based on a matching of the first characteristics with second characteristics associated with a task to be completed;
wherein the processor is configured to determine an optimal proposed model including at least one candidate module from the set of candidate modules based on an accuracy rank and a runtime execution rank of the candidate modules in the set of candidate modules; and
wherein the processor is configured to execute the task using the optimal proposed model.
